(19) United States
(12) Patent Application Publication
(10) Pub. No.: US 2025/0335947 A1
(43) Pub. Date: Oct. 30, 2025

(54) SYSTEMS AND METHODS FOR USE IN DEFINING DYNAMIC INSIGHTS

(71) Applicant: MASTERCARD ASIA/PACIFIC PTE. LTD., SINGAPORE (SG)

(72) Inventors: Sushil More, Singapore (SG); Jelena Popovic, Novi Beograd (RS); Marco Igliozzi, Rome (IT); Nitisha Putti, Singapore (SG); Rahul Ajmani, Mumbai (IN)

(21) Appl. No.: 19/189,659

(22) Filed: Apr. 25, 2025

Related U.S. Application Data
(60) Provisional application No. 63/639,400, filed on Apr. 26, 2024.

(51) Int. Cl. G06Q 30/0204; G06T 11/20

(52) U.S. Cl. CPC G06Q 30/0205; G06T 11/206

(57) ABSTRACT

Systems and methods are provided for defining dynamic insights for a proposition. One example computer-implemented method includes in response to a request including a card value proposition (CVP) from a relying institution, accessing data from one or more databases, the data including card comparison data and benefit data; compiling a data structure, from the accessed data, the data structure including data for one or more segments including card peers for the CVP, a peers as defined by the geographic limitations, and the CVP, for each of multiple parameters; calculating representative values for the multiple parameters included in the data structure; generating a graphic having a spoke specific to each of the multiple parameters and a line based on the calculated values for each of the card peers, peers defined by the graphic limitation, and CVP; and presenting the graphic to the relying institution, in response to the request.

### CROSS-REFERENCE TO RELATED APPLICATION

This application claims the benefit of, and priority to, U.S. Patent Application No. 63/639,400, filed on Apr. 26, 2024. The entire disclosure of the above application is incorporated herein by reference.

### FIELD

The present disclosure is generally directed to systems and methods for use in defining dynamic insights, and in particular, for use in defining dynamic insights based on integration of disparate databases and preferences.

### BACKGROUND

This section provides background information related to the present disclosure which is not necessarily prior art.

Data analysis is known to be used to develop insights into one or more subjects. Quality of the insights is often dependent on the quality and sufficiency of the data accessed and available for use in the data analysis. In connection with payment related data, the data is known to be compiled based on transactions that are initiated through various parties, including, for example, processing networks, whereby the parties often compile data representative of the transactions. The parties may then analyze the data in order to develop specific insights for the parties to impact, alter, change, or continue certain services, etc.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in defining dynamic insights;

FIG. 2A-2C illustrate example data structures and line graphics indicative of benchmarks, which are generated using the system of FIG. 1;

FIG. 3 is a block diagram of an example computing device that may be used in the system of FIG. 1; and

FIG. 4 illustrates an example method of the present disclosure, which may be implemented in connection with the system of FIG. 1 for use in defining dynamic insights.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Financial institutions leverage data associated with products (e.g., services, etc.) offered by the financial institutions to change product offerings based on customer demands. Often, however, the financial institutions rely on incomplete data, which may skew the insights revealed by reliance on the incomplete data. In this manner, a comprehensive understanding of the data, in connection with evolving conditions (e.g., market conditions for offered products, etc.), etc., and proper, dynamic benchmarking of the data is deficient. A technical problem exists, therefore, in the compilation of the data to enable, facilitate, etc. a comprehensive understanding of the data (as is needed, desired, etc. by the financial institutions and/or others that rely on and/or utilize the data).

Uniquely, the systems and methods herein provide for defining of dynamic insights based on integration of disparate databases and preferences.

In particular, an intelligence platform accesses specific data related to accounts, where the data includes card comparison data, benefit data, etc. The intelligence platform then compiles the data into parameter charts (e.g., benefits, technical features, pricing, etc.) (e.g., for account/card peers, market peers, etc.), which are graphically displayed to a relying institution (e.g., as visually presented standardized constructs or benchmarks, etc.), along with a proposition for the relying institution (e.g., existing account, proposed account, etc.), whereby the relying institution is permitted to assess the value and competitiveness of the proposition relative to the benchmarks (e.g., at scale, etc.). In this manner, as the parameters are compiled on existing data, and are refreshed at one or more intervals, the benchmarks are indicative of evolving market conditions as dynamic insights into the offerings in the industry, region, etc.

In this way, the systems and methods herein provide a technical solution to the technical problem of incomplete data, through offering dynamic insights based, at least in part, on the manner in which the intelligence platform integrates disparate databases and preferences.

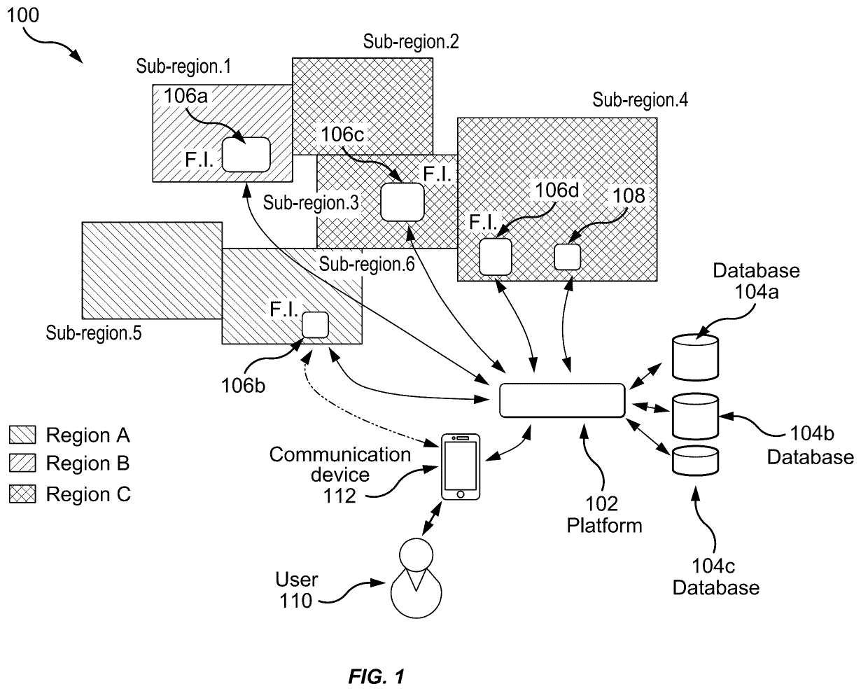

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, product offerings, accessibility to databases, privacy concerns and/or requirements, etc.

The illustrated system 100 generally includes an intelligence platform 102, multiple databases 104a-c, multiple financial institutions 106a-d, and a relying institution 108, each of which is coupled to one or more networks. The one or more networks may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. In addition, the system 100 also includes an example user 110, which is associated with a communication device 112, where the communication device 112 is coupled to one or more networks to communicate, for example, to the intelligence platform 102 and/or the financial institutions 106a-d, etc.

In this example embodiment, the intelligence platform 102 is generally configured to define dynamic insights, based on data included in the databases 104a-c, and to present the insight(s) to the relying institution 108. In this embodiment, the insights are specific to payment cards, or payment accounts, and particular combinations of pricing, benefits, etc., per region, country, etc., but may be otherwise in other embodiments.

As shown in FIG. 1, the databases 104a-c each include disparate data (relative to one another) related to payment accounts.

In this example embodiment, the database 104a, for example, includes a data structure (e.g., a table, etc.) populated with card comparison data. The card comparison data includes, without limitation, a unique card identifier, card name, country, issuer name, issuer type, card tier, card type (e.g., contactless, etc.), card segment, issuer geographic (e.g., national, etc.), currency, fees (e.g., percentage, fixed, etc.), type of fees, limits, interest terms (e.g., rate, revolving, installment, etc.), alerts, authentication, controls, tokenization, provisioning restrictions (e.g., wallet, wearable, etc.), benefits, etc. The card comparison data generally includes values (e.g., yes, no, 3.56%, $50, etc.), to indicate the applicability of the data, or value thereof, for the specific payment account, etc.

It should be appreciated that various other data, which is descriptive of particular payment accounts, may be included in the card comparison data, such that different cards may be compared to one another based on various metrics indicated thereby. It should also be understood that while “card” is used herein, card comparison data should not be understood to be limited to accounts associated with physical cards, and thus, may also extend to accounts not associated with physical cards (e.g., virtual accounts, etc.).

It should be further appreciated that the database 104a further includes a data structure populated with benefit data (e.g., benefits, rewards, etc.) for the accounts. The benefit data may include, without limitation, benefit name (e.g., as defined by the financial institution offering the same, etc.), description of the benefit, category of the benefit, card program offering the benefit, type of benefit and target market for the benefit, etc.

In this embodiment, the database 104a further includers a card benefit mapper data structure, which defines the mapping between the benefits listed in the benefit data from the specific benefit data structure to benefit data in the card comparison data, i.e., disparate data structures. That is, as the benefit data is defined by the issuer of the card (e.g., one of the financial institution 106a-d, etc.), the name and description of the benefit may be different among the different accounts. For example, a financial institution may apply a proprietary name to specific benefits. In turn, the mapper data is configured to permit the intelligence platform 102 to convert, assign, or map different benefit data, from different financial institutions, to a generic benefit, which is associated, in this example, with a benefit category.

Table 1 below indicates example mapper data for mapping between the benefit data and the card comparison data, as described.

TABLE 1

| S/N | Benefit Name | Mapping to CC |
|---|---|---|
| 1 | World Elite Lounge Program | Airport Lounge |
| 2 | Mastercard Airport concierge | Concierge |
| 3 | Medical Tourism concierge | Concierge |
| 4 | Rental Collision & Loss Damage Waiver | Insurance |

It should be appreciated that the mapping may include various entries, where a specific benefit is listed (e.g., as offered by a financial institution, etc.) (e.g., issuer-specific benefit, etc.), and mapped to a general benefit, and potentially, a category of benefit(s), for comparison to other benefits.

Further, in this example embodiment, the database 104b includes consumer preference data of one or more users associated with use of payment accounts, in one or more regions, etc.

The consumer preference data is compiled based on, among other things, structured survey responses from users, who generally include account holders or users who are looking to become account holders. The survey questions may include, for example, queries as to the preference of the users for specific benefits, where the benefits may include medical assistance, pet insurance, e-commerce insurance, identity protection, airport lounge access, ATM theft protection, WI-FI access, auto rental insurance, shopping insurance, etc. The benefits may be separated into categories, such as, for example, travel, concierge, insurance, lifestyle, rewards, etc. The users may be queried for each, or some of the benefits above, and the structured survey responses from the users may include a ranking of the benefits, for example, on a scale of 1-5, or 1-3, etc., or qualitative, scaled terms (e.g., high, medium, low, etc.), where the ranking indicates a scale of importance to the user.

Table 2 below indicates an example summary of structured survey responses, aggregated over the account type (e.g., card tier, etc.) and also over region (e.g., country, etc.), which may be generated/compiled consistent with the above.

TABLE 2

| | | Account Type | | Region | |
|---|---|---|---|---|---|
| | | Positive | Total | Positive | Total |
| Benefit | Category | Res | Count | Res | Count |
| Identity protection | Insurance | 4 | 27 | 61 | 122 |
| Airport Lounge | Travel | 30 | 27 | 101 | 122 |
| Concierge | Travel | 3 | 27 | 61 | 122 |
| Shopping insurance | Lifestyle | 4 | 27 | 61 | 122 |
| . . . | . . . | . . . | . . . | . . . | . . . |

It should be appreciated that the database 104b may include additional structured or unstructured survey responses, from users, in the region, or potentially sub-regions, etc., for other benefits, or more generally, other account features, etc. Often, the queries are directed to general benefits, rather than specific benefits offered by certain ones of the financial institutions, etc.

As it relates to the user preferences, the surveys may be initiated by the intelligence platform 102 or by one or more of the financial institutions 106a-d. In this embodiment, the intelligence platform 102 is configured to compile a survey specific to payment accounts, and more specifically, available benefits, pricing, etc. The intelligence platform 102 is configured to direct the survey to the user 110, for example, via the communication device 112 (as indicated by the solid, arrowed line in FIG. 1), and to receive the survey responses, as structured survey responses, from the communication device 112. The survey may be presented through a website, or other web-based interface (or software included in the communication device 112 (e.g., an application, etc.)), whereby the user 110 sequences through the one or more queries and provides a response to each (e.g., assessing benefits, ranking benefits, etc.). The structured survey response may be returned to the intelligence platform 102, through an API call, or other suitable techniques (e.g., email, SMS message, application-based communication, etc.).

Additionally, or alternatively, the financial institution 106b, for example, may be configured to direct the survey to the user 110, via the communication device 112 (as indicated by the dotted, arrowed line in FIG. 1) (e.g., via an application specific to the financial institution 106b installed at the communication device 112, etc.) (e.g., via one or more interfaces, etc.). The survey may be compiled by the financial institution 106b, or the intelligence platform 102. Regardless, the financial institution 106b is configured to submit the survey to the user 110, to receive the responses form the user 110, from the communication device 112, and to return the structured survey responses to the intelligence platform 102.

The intelligence platform 102 is configured, in turn, based on the above, to store the structured survey responses in the database 104b.

And, in this example embodiment, the database 104c includes additional data related to the payment accounts and comparisons thereof. For example, the additional data may include currency tables, which provide for conversion of different currencies into a common currency. For example, the currency table may define a conversion from native currencies in Egypt, Kenya, Kuwait, Israel, Saudi Arabia, to U.S. dollars, or vice-versa. Based on the currency table, therefore, fees and/or pricing associated with the different accounts may be converted for suitable comparison, etc. It should be appreciated that other tables may be included as well to provide for other suitable conversions for the comparison(s) explained below.

With continued reference to FIG. 1, the financial institutions 106a-d and the relying institution 108 are each financial institutions (e.g., banks, credit unions, etc.), which are configured to offer payment accounts (e.g., card accounts, etc.), to users, including, the user 110. The payment accounts may include credit accounts (e.g., associated with credit cards, etc.), debit accounts (e.g., associated with debit cards, etc.), or other types of accounts (e.g., prepaid, etc.). In general, the institutions 106a-d, 108 are configured to impose terms on the accounts, such as those explained above, where the terms may be understood to be the card value proposition (CV P) for the specific account. In connection therewith, the institutions 106a-d, 108 attempt to associate desirable terms, including, specifically, benefits, technical features, pricing, etc., to attract users to apply for the account(s).

Relatedly, as illustrated in FIG. 1, the financial institutions 106a-d and the relying institution 108 (and many other institutions) are located in one or more regions, and also, in this example, in one or more sub-regions. In this example embodiment, the regions include a number of countries (e.g., separated by government agreement, regulation, etc.) (e.g., Middle East, North Africa, Sub-Sahara Africa, Eastern Europe, etc.) and the sub-regions are the individual countries within the regions. It should be appreciated that other constructs of regions and/or sub-regions may be employed in other embodiments. For example, a region may be a country, and a sub-region may be the northeast, west, south, states, territories, counties, cities, etc. of that country, etc.).

As shown in FIG. 1, the system 100 includes three regions, each of which is designated by the unique hatching in the regions (as indicated by the key, Region A, Region B, and Region C). The regions, in turn, include sub-regions. The sub-regions are referenced, for example, as sub-region.1, sub-region.2, sub-region.3, sub-region.4, sub-region.5, and sub-region.6, where each is visually included in one of Regions A, B, or C, as shown in FIG. 1. That is, sub-region.5 and sub-region.6 are located in Region A; sub-region.1 is located ion Region B; and sub-region.2, sub-region.4 and sub-region.6 are located in Region C. Further, as shown, the financial institutions 106a-d and the relying institution 108 are each located in one of the regions and one of the sub-regions.

That said, it should be appreciated that a different number of regions, sub-regions and institutions located therein may be employed in other embodiments of the present disclosure.

It should also be appreciated that the regions and sub-regions may be integrated in the manner in which the above data is stored, or the manner in which the data is accessed. That is, datasets within the databases 104a-c may be region specific, or sub-region specific, or may be generic to the different regions and sub-regions, whereby retrieving data from the databases 104a-c may include, in various embodiments, a regional and/or sub-regional filter.

In this example embodiment, as explained above, the intelligence platform 102 is configured to receive a request to advise the relying institution 108 about dynamic insight(s) associated with payment accounts, and specifically, terms of a CVP offering by the relying institution 108, for example. The request may originate at the relying institution 108, or internal to the intelligence platform 102 (or an associated entity (e.g., a payment processing network (e.g., MASTERCARD, VISA, etc.,), etc.)). The request includes the CVP, which includes the benefits, technical features, pricing, etc., and also a card program. Example card programs may include standard, platinum, gold, diamond, world, elite, etc. In addition, the CV P indicates a region or sub-region in which the card is offered or to be offered, i.e., the CVP may be presently offered by the relying institution 108 or proposed to be offered by the relying institution 108.

In connection therewith, the intelligence platform 102 is configured to compile a dataset consistent with the request.

Initially, in this embodiment, the intelligence platform 102 is configured to limit the dataset by geography. That is, for example, the dataset will be limited to the sub-region in which the relying institution 108 is located (e.g., sub-region.4 in FIG. 1, etc.), or alternatively, the region in which the relying institution 108 is located (e.g., Region C, etc.). The geographic limitation of the dataset may be based, for example, on volume of available data within the sub-region (e.g., to maintain privacy and/or regulatory compliance, etc.), or consistency of data in the region, etc. In general, the dataset is intended to be indicative of factors relevant to the relying institution 108. In this particular example, the dataset is limited to sub-region.4, whereby only accounts issued in sub-region.4 are compiled into the datasets.

It should be appreciated that in this example, if data had not been available for sub-region.4, the intelligence platform 102 may have been configured to limit the dataset to Region C (i.e., the region in which sub-region.4 is located).

Similarly, the intelligence platform 102 is configured to limit the dataset to a type of card program consistent with the card program indicated in the request. Here, the CV P includes a world-type program, whereby only accounts in the card comparison data specific to world-type program cards are compiled into the dataset.

Notwithstanding the above, it should be appreciated that other limitations may be employed, or omitted, in compiling the dataset.

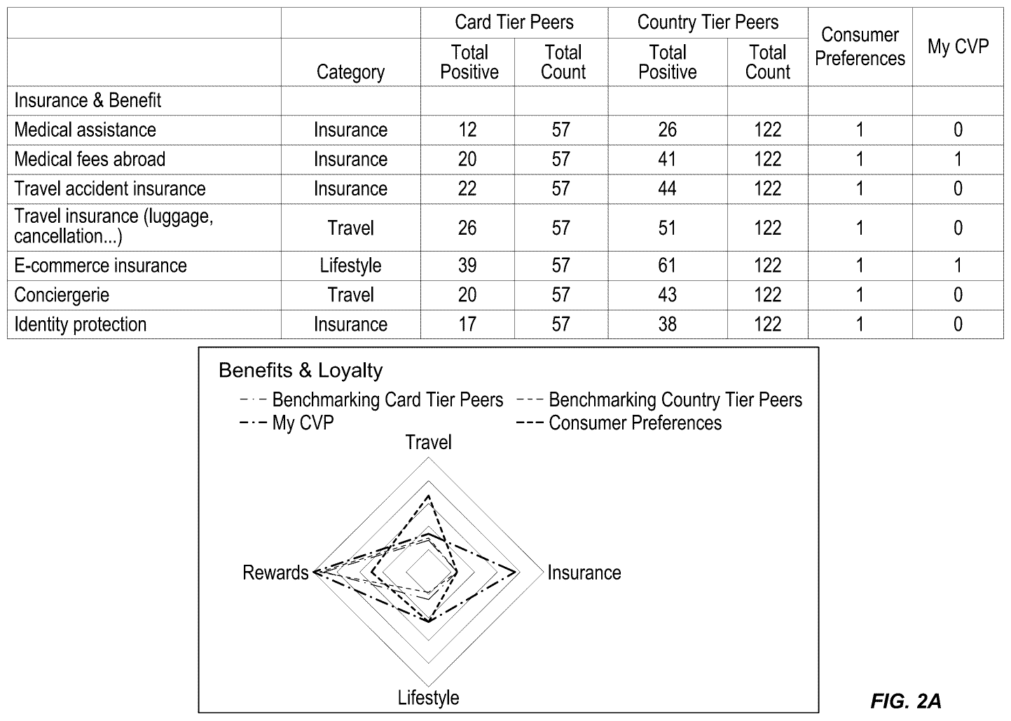

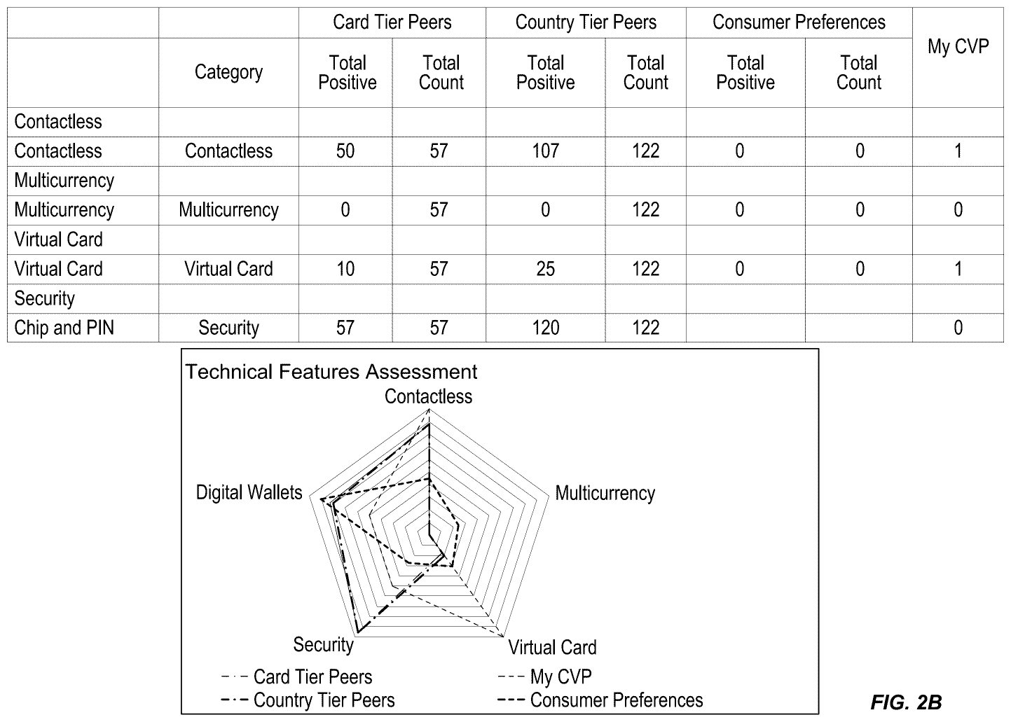

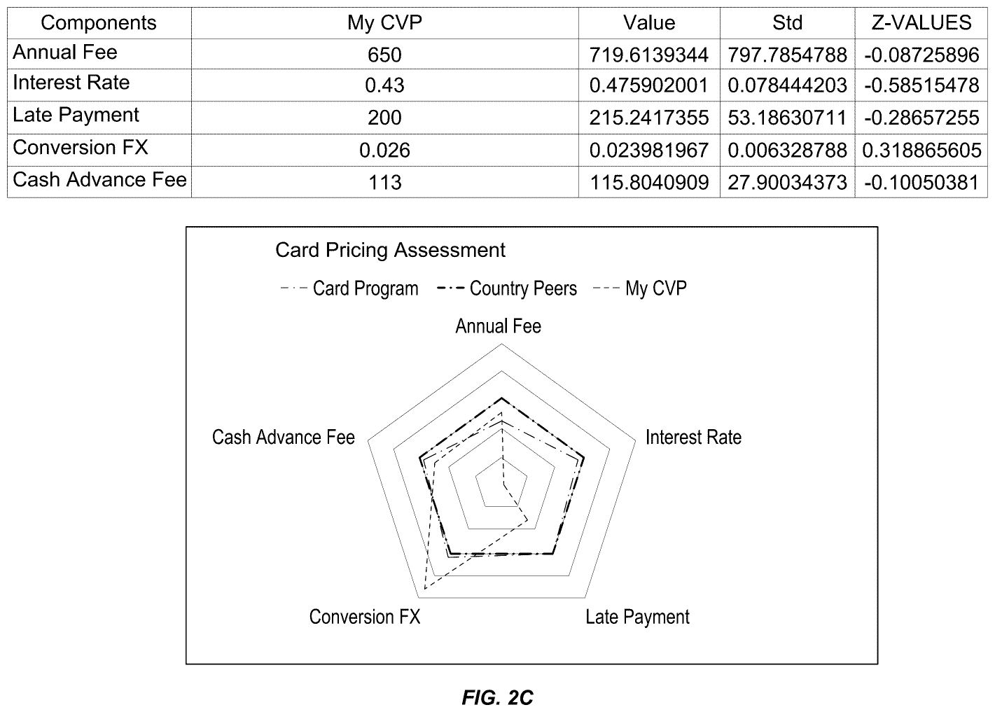

In this example embodiment, based on the limitations, the platform 102 is configured to compile three data structures within the dataset. The first data structure includes the benefits of the payment accounts, which is compiled from the card comparison data and the benefit data, via the associated mapping therebetween. Consistent with the above, the benefit data includes, without limitation, medical assistance, travel accident insurance, travel insurance, e-commerce insurance, concierge services, identity protection, airport lounges, shopping insurance, ATM theft protection, etc. The data structure further includes the category of the benefit (e.g., insurance, travel, lifestyle, rewards, etc.), the occurrence of the benefit in card accounts and a total occurrence of cards (in card tiers (i.e., the cards in the same tier or program in the request) and in country tiers (i.e., in sub-region.4, or potentially, the Region C, or both separately)), user preferences from the structured survey responses, and also the CVP defined by the relying institution 108, as indicated in the example dataset in FIG. 2A. In this way, the data structure includes four classes.

It should be appreciated that the intelligence platform 102 may be configured to weight values associated with the user preferences to ensure the preferences sufficiently reflect the user's survey response(s). That is, for example, where the user preference for travel insurance is ranked #1, the intelligence platform 102 is configured to allocate 3 points to travel insurance, while only allocating 1 point to concierge, where the user preference for concierge is ranked #3.

It should be appreciated that the intelligence platform 102 may be configured in various manners to weight or not weight the user preferences, in other embodiments, in order to promote proper interpretation thereof.

In connection therewith, the intelligence platform 102 is configured to calculate values indicative of the positive occurrence over the total number of occurrences, per category of the benefit (e.g., insurance, travel, lifestyle, rewards, etc.), for the card tier peers, the country tier peers (and potentially, the region peers), the user preferences, and the CV P, as shown, for example, based on the data structure in FIG. 2A. In this example, the values may be indicated as percentages of positive responses relative to the total responses for each aggregated category (e.g., cards having the benefit, users preferring the benefit, etc.), whereby a value is calculated for insurance, travel, lifestyle, rewards, for each of card peers, country peers, preferences and CV P.

The intelligence platform 102 is configured to compile a four-line graphic (e.g., a spider-web graph, etc.) based on the calculated values as shown in FIG. 2A for benefits of the payment accounts.

The second data structure includes technical features of the payment accounts, such as for example, contactless, multicurrency, virtual card, chip and pin, alerts, branded wallets (e.g., APPLE PAY, GOOGLE PAY, SAMSUNG PAY, etc., services; etc.), wearable devices (e.g., GARMIN, FITBIT, etc.) and user preferences from the structured survey responses indicating positive responses in total responses, as indicated in the example dataset in FIG. 2B.

In connection therewith, the intelligence platform 102 is configured to calculate values indicative of the positive occurrence over the total number of occurrences, per category of the technical feature, for the card tier peers, the country tier peers, the user preferences, and the CV P, as shown, for example, based on the data structure in FIG. 2B. In this example, the values are the percentages of positive responses for each aggregated category (e.g., cards having the technical features, users preferring the technical features, etc.), whereby a value is calculated for contactless, multicurrency, virtual card, chip and pin, digital wallets, for each of card peers, country peers, preferences and CV P.

The intelligence platform 102 is configured to compile a four-line graphic (e.g., a spider-web graph, etc.) based on the calculated values, as shown in FIG. 2B for technical features of the payment accounts.

The third the data structure includes card pricing data, from the card comparison data, via the associated currency table (e.g., to ensure uniform currency, etc.). The card pricing data includes, without limitation, annual fees, interest rates, late payments, currency conversions, cash advance fees, etc. While these may be specific for credit type cards, in some examples, other pricing data may be used for debit-type cards, including, for example, debit use dimensions such as annual fees, conversion FXs, ATMs (partners versus non-partners) and replacement card fees, etc. The card pricing is calculated as a value in the common currency, along with a standard deviation and z-score, for each of the card pricing data, for the card program, country peers and CVP.

The intelligence platform 102 is configured to compile the pricing as an average or a mean of the values for the card peers and country peers (and, potentially region peers). Also, the intelligence platform 102 is configured to calculate z-scores for the pricing of the CVP relative to the country-based statistics, as shown, for example, based on the data structure in FIG. 2C. In this example, the values for the CVP are based on z-score methodology to assess the statistical positioning and/or leveraging on standard deviation of the pricing data, with the normal distribution being at zero, with deviations above or below. As such, the scale is not fixed from zero to X, but, rather, is dynamic based, in part, on the average z-scores and CV P pricing. The CVP pricing is calculated by subtracting the mean value of the attribute and dividing that difference by the standard deviation of the column ((x-mean)/standard deviation), as is presented in FIG. 2C. In this way, the values for the card peers, country peers and the CV P are calculated by the intelligence platform 102 for a dynamic approach for purposes of comparison (e.g., comparing in a standardized manner (e.g., annual fee ($0 to interest rate (%), etc.).

It should be appreciated that the values may be otherwise standardized or converted to a uniform scale in other embodiments (e.g., to enable for visualization with different attributes, etc.), and may be processed further to eliminate or minimize potential impact of outliers within the data.

Based thereon, the intelligence platform 102 is configured to compile a three-line graphic (e.g., a spider-web graph, etc.) based on the calculated values for the pricing of the payment accounts, as shown in FIG. 2C, for technical features of the payment accounts.

Each of the line graphics illustrated in FIGS. 2A-2C are considered to be a dynamic benchmark for users in assessing the CVP. As such, in connection with the above, in this example embodiment, the intelligence platform 102 is configured to output the line graphics (e.g., spider-web graphs, etc.), which are displayed, presented, or otherwise provided to the relying institution 108.

The relying institution, in turn, may be informed, through the dynamic benchmarks or insights of the line graphics, to continue to offer the CVP, or decide to offer the CVP, or potentially, adjust the CV P, for users within the sub-region, i.e., the sub-region.4 in the above example, or more generally, the region, i.e., the Region C.

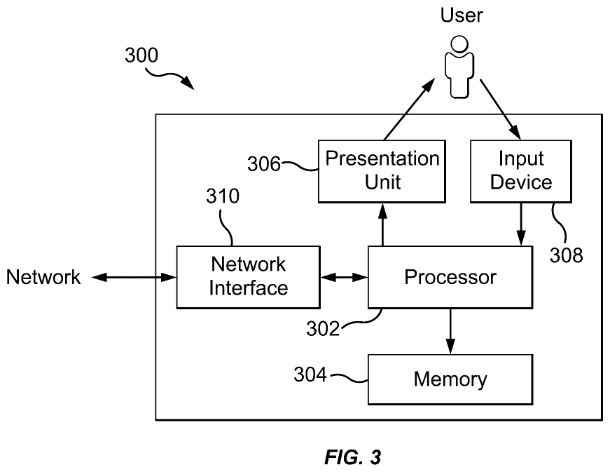

FIG. 3 illustrates an example computing device 300 that may be used in the system 100 of FIG. 1. The computing device 300 may include, for example, one or more servers, workstations, personal computers, laptops, tablets, smartphones, etc. In addition, the computing device 300 may include a single computing device, or it may include multiple computing devices located in close proximity or distributed over a geographic region, so long as the computing devices are specifically configured to function as described herein. In the example embodiment of FIG. 1, each of the intelligence platform 102, the databases 104a-c, the financial institutions 106a-d, the relying institution 108, and the communication device 112 may be considered, may include, and/or may be implemented in a computing device consistent with the computing device 300, coupled to (and in communication with) the one or more networks of the system 100. However, the system 100 should not be considered to be limited to the computing device 300, as described below, as different computing devices and/or arrangements of computing devices may be used in other embodiments. In addition, different components and/or arrangements of components may be used in other computing devices.

Referring to FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (A SIC), a programmable logic device (PLD), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROM s, thumb drives, floppy disks, tapes, hard disks, and/or any other type of volatile or nonvolatile physical or tangible computer-readable media. The memory 304 may be configured to store, without limitation, card comparison data, benefit data, pricing data, and/or other types of data (and/or data structures) suitable for use as described herein.

Furthermore, in various embodiments, computer-executable instructions may be stored in the memory 304 for execution by the processor 302 to cause the processor 302 to perform one or more of the functions described herein, such that the memory 304 is a physical, tangible, and non-transitory computer readable storage media. Such instructions often improve the efficiencies and/or performance of the processor 302 and/or other computer system components configured to perform one or more of the various operations herein (e.g., one or more of the operations of method 400, etc.), whereby upon (or in connection with) performing such operation(s) the computing device 300 may be transformed into a special purpose computing device. It should be appreciated that the memory 304 may include a variety of different memories, each implemented in one or more of the functions or processes described herein.

In the example embodiment, the computing device 300 also includes a presentation unit 306 that is coupled to (and is in communication with) the processor 302 (however, it should be appreciated that the computing device 300 could include output devices other than the presentation unit 306, etc.). The presentation unit 306 outputs information, visually or audibly, for example, to a user of the computing device 300 (e.g., line graphics, survey queries, etc.), etc. And, various interfaces may be displayed at computing device 300, and in particular at presentation unit 306, to display certain information in connection therewith. The presentation unit 306 may include, without limitation, a liquid crystal display (LCD), a light-emitting diode (LED) display, an organic LED (OLED) display, an “electronic ink” display, speakers, etc. In some embodiments, the presentation unit 306 may include multiple devices.

In addition, the computing device 300 includes an input device 308 that receives inputs from the user 110 (i.e., user inputs) of the computing device 300 such as, for example, user inputs to select one or more user preferences (e.g., input survey responses, etc.), to input requests, etc., as further described below. The input device 308 may include a single input device or multiple input devices. The input device 308 is coupled to (and is in communication with) the processor 302 and may include, for example, one or more of a keyboard, a pointing device, a mouse, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 306 and the input device 308.

Further, the illustrated computing device 300 also includes a network interface 310 coupled to (and in communication with) the processor 302 and the memory 304. The network interface 310 may include, without limitation, a wired network adapter, a wireless network, a mobile network adapter, or other device capable of communicating to one or more different networks herein and/or with other devices described herein. In some example embodiments, the computing device 300 may include the processor 302 and one or more network interfaces incorporated into or with the processor 302.

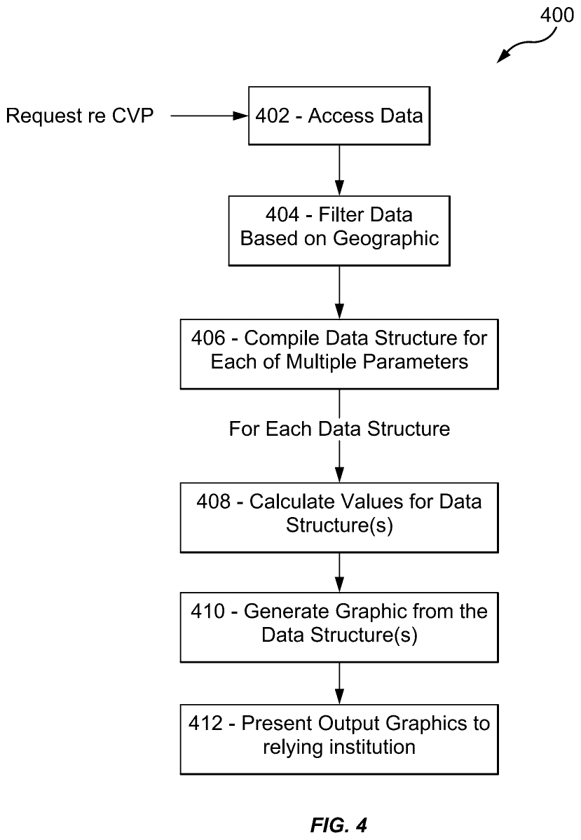

FIG. 4 illustrates an example method 400 for use in defining dynamic insights. The example method 400 is described as implemented in system 100, with reference to the intelligence platform 102, and with additional reference to the computing device 300. That said, however, the methods herein should not be understood to be limited to the system 100 or the computing device 300, as the methods may be implemented in other systems and/or computing devices. Likewise, the systems and the computing devices herein should not be understood to be limited to the example method 400.

At the outset in the method 400, a request is provided to the intelligence platform 102, either from the relying institution 108 or another entity or user associated with the relying institution 108, or otherwise. The request includes a card value proposition (CV P), which includes a specific region in which a card is to be offered along with the program of the card and then the benefits, pricing, etc., of the card. The CVP may be currently offered, or only prospective.

In response, at 402, the intelligence platform 102 accesses data related to the request, which includes, generally, card comparison data (as explained above) for existing cards, and benefit data for the existing cards. The intelligence platform 102 may further access mappings between the card comparison data and the benefit data for the cards.

In addition, the intelligence platform 102 access user preference data, which includes structure survey responses from numerous users associated with the existing cards, the relying institution 108, or otherwise accessible to the intelligence platform 102, the relying institution 108, etc. The user preference data is specific to different features of cards, including, specifically, benefits, technical features, pricing, etc.

At 404, the intelligence platform 102 filters the accessed data to a specific geographic limitation. Here, the geographic limitation is either a region, or sub-region, from the request, to which the CVP is directed. It should be appreciated that the region may be broader than the sub-region included in the CVP, in some embodiments, based on the available accessed data.

What's more, the intelligence platform 102 may be configured to further, or alternatively, filter based on the program of the CVP (e.g., class or type of card). As such, where the CVP is directed to a gold card, the intelligence platform 102 filters the accessed data to maintain card comparison data for gold cards (in the region).

The intelligence platform 102 then compiles, at 406, one or more data structures for each of multiple parameters. In this example embodiment, the parameters are specific to class features of the cards. The classes, for example, include benefits, technical features and pricing. And, then, each class includes specific parameters. Example parameters for each of the above classes are included in Table 3, below.

TABLE 3

| Class | Parameters |
|---|---|
| Benefit | Categories: Insurance, Rewards, Lifestyle, Travel |
| Technical | Contactless, multicurrency, virtual card, tokenization, |
| Features | chip and pin, alerts, digital wallets |
| Pricing | annual fee, interest rate, late payment, currency |
| | conversion, cash advance fee, conversion FX, ATM |
| | (Partnership versus Non partners), replacement card |
| | fees, etc. |

It should be appreciated that the intelligence platform 102 may compile a data structure for each class, or only some of the classes described above, and for some or all of the parameters (or different parameters) in other embodiments.

What's more, the data structures are also compiled to includes segments, where the segments includes card peers (which are similar cards from the filtered data), region peers (which are cards from the same region), user preferences and the CV P.

At 408, the intelligence platform calculates values, from the data structure, for each of the multiple parameters, and each of the segments: card peers, region peers, user preferences and CVP. The values may include an average or mean, or may includes a percentage, or z-score, as explained above. It should be understood that, for pricing, there may be no values for user preferences.

Next, at 410, the intelligence platform 102 generates a graphic for each data structure, where the graphics each include a spoke for one or more of the parameters, and then a line for each of the segments, whereby the line intersects the spoke at the calculated values. The graphics, in this example, include spider graphics.

And, finally, as shown in FIG. 4, the intelligence platform 102 presents, at 412, the output graphic(s) to the relying institution 108, in response to the initial request. The relying institution 108 may then decide to pursue, modify, or cancel attributes and/or data from cards offered thereby.

In view of the above, the systems and methods herein provide an integrated benchmarking basis for market analysis, utilizing a set of disparate data sources to generate dynamic benchmarks that allow relaying parties to understand offerings from peers as well as market and user preferences, to enable enhanced insights in a rapidly evolving space. In particular, the intelligence platform accesses specific data related to accounts and compiles the data into parameter charts for a specific card value proposition (CVP) (e.g., benefits, technical features, pricing, etc.) (e.g., for account/card peers, market peers, etc.), which are graphically displayed to a relying institution (e.g., as visually presented standardized constructs or benchmarks, etc.). Based on the unique, graphically composed data, the relying institution is enabled, as a technical solution, to assess the value of the CVP relative to included benchmarks (e.g., at scale, etc.). In this manner, the benchmarks provide real-time indication of conditions (e.g., based on existing data, which is refreshed at one or more intervals, etc.) as dynamic insights into the offerings in the industry, region, etc.

A gain and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the operations recited herein (including in the claims).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in defining dynamic insights for a proposition, the method comprising:
in response to a request including a card value proposition (CV P) from a relying institution, accessing, by a computing device, data from one or more databases, the data including card comparison data and benefit data;
filtering, by the computing device, the data based on a geographic limitation;
compiling, by the computing device, a data structure, from the filtered data, the data structure including data for one or more segments including card peers for the CVP, a peers as defined by the geographic limitations, and the CVP, for each of multiple parameters;
calculating, by the computing device, representative values for the multiple parameters included in the data structure;
generating, by the computing device, a graphic having a spoke specific to each of the multiple parameters and a line based on the calculated values for each of the card peers, peers defined by the graphic limitation, and CVP; and
presenting, by the computing device, the graphic to the relying institution, in response to the request.

2. The computer-implemented method of claim 1, wherein the geographic limitation is one of a region and a sub-region, in which the relying institution is located.

3. The computer-implemented method of claim 2, wherein filtering the data is further based on a card program included in the CVP.

4. The computer-implemented method of claim 1, wherein the one or more databases include multiple databases, each of the multiple databases associated with a financial institution;
wherein compiling the data structure includes compiling multiple data structures; and
wherein the multiple data structures include a data structure specific to benefits, a data structure specific to technical features, and/or a data structure specific to pricing.

5. The computer-implemented method of claim 4, wherein the parameters include insurance, travel, lifestyle and rewards for the data structure specific to benefits.

6. The computer-implemented method of claim 4, wherein the parameters include contactless, virtual card, alerts, and digital wallet for the data structure specific to technical features.

7. The computer-implemented method of claim 4, wherein the parameters include annual fee, interest rate, and late payment fee for the data structure specific to pricing.

8. The computer-implemented method of claim 4, wherein the calculated values are percentages for at least one of the one or more segments; and
wherein the graphic includes a spider graph for each of the multiple data structures.

9. The computer-implemented method of claim 1, wherein the graphic includes a spider graph.

10. A system for use in defining dynamic insights for a proposition, the system comprising:
an intelligence platform computing device, which is configured, by executable instructions, to,
in response to a request including a card value proposition (CV P) from a relying institution, access data from one or more databases, the data including card comparison data and benefit data;
compile a data structure, from the accessed data, the data structure including data for one or more segments including card peers for the CVP, a peers as defined by a geographic limitations associated with the relaying institution, and the CVP, for each of multiple parameters;
calculate representative values for the multiple parameters included in the data structure;
generate a graphic having a spoke specific to each of the multiple parameters and a line based on the calculated values for each of the card peers, peers defined by the graphic limitation, and CVP; and
present the graphic to the relying institution, in response to the request.

11. The system of claim 10, wherein the intelligence platform computing device is configured, by the executable instructions, to: filter the data based on a geographic limitation;
and compile the data structure from the filtered data.

12. The system of claim 11, wherein the geographic limitation is a region, in which the relying institution is located, and a card program included in the CVP.

13. The system of claim 10, wherein the one or more databases include multiple databases, each of the databases associated with a financial institution; and
wherein the data structure includes multiple data structures; and
wherein the multiple data structures include a data structure specific to benefits, a data structure specific to technical features, and/or a data structure specific to pricing.

14. The system of claim 13, wherein the parameters include insurance, travel, lifestyle and rewards for the data structure specific to benefits; and/or
wherein the parameters include contactless, virtual card, alerts, and digital wallet for the data structure specific to technical features; and/or
wherein the parameters include annual fee, interest rate, and late payment fee for the data structure specific to pricing.

15. The system of claim 14, wherein the calculated values are percentages for at least one of the one or more segments; and
wherein the graphic includes a spider graph for each of the multiple data structures.

16. The system of claim 10, wherein the graphic includes a spider graph.

17. A non-transitory computer-readable storage medium comprising executable instructions, which when executed by at least one processor of an intelligence platform computing device, cause the at least one processor to:
in response to a request including a card value proposition (CV P) from a relying institution, access data from one or more databases, the data including card comparison data and benefit data;
filter the data based on a geographic limitation;
compile a data structure, from the filtered data, the data structure including data for one or more segments including card peers for the CV P, a peers as defined by a geographic limitations associated with the relaying institution, and the CV P, for each of multiple parameters;
calculate representative values for the multiple parameters included in the data structure;
generate a graphic having a spoke specific to each of the multiple parameters and a line based on the calculated values for each of the card peers, peers defined by the graphic limitation, and CVP; and
present the graphic to the relying institution, in response to the request.

18. The non-transitory computer-readable storage medium of claim 17, wherein the geographic limitation is a region, in which the relying institution is located.

19. The non-transitory computer-readable storage medium of claim 17, wherein the one or more databases include multiple databases, each of the databases associated with a financial institution;
wherein the data structure includes multiple data structures; and
wherein the graphic includes a spider graph for each of the multiple data structures.

20. The non-transitory computer-readable storage medium of claim 19, wherein the parameters include insurance, travel, lifestyle and rewards for one of the multiple data structures specific to benefits; and/or
wherein the parameters include contactless, virtual card, alerts, and digital wallet for one of the multiple data structures specific to technical features; and/or
wherein the parameters include annual fee, interest rate, and late payment fee for one of the multiple data structures specific to pricing.
